(19) United States
(12) Patent Application Publication
(10) Pub. No.: US 2009/0300618 A1
(43) Pub. Date: Dec. 3, 2009

(54) Method and Apparatus to Facilitate Negotiation of a Selection of Capabilities to Be Employed When Facilitating a Task

(75) Inventors: Zhi Fu, Lake Zurich, IL (US); John C. Strassner, North Barrington, IL (US)

Correspondence Address: MOTOROLA/FETF, 120 SOUTH LASALLE STREET, SUITE 1600, CHICAGO, IL, 60603-3406, US

(73) Assignee: MOTOROLA, INC., Schaumburg, IL (US)

(21) Appl. No.: 12/132,434

(22) Filed: Jun. 3, 2008

(51) Int. Cl. G06F 9/46

(52) U.S. Cl. 718/100

(57) ABSTRACT

Determine (101) a particular task to be autonomously facilitated in cooperation with another entity that also has autonomous task facilitation capabilities and then identify (102) particular supportable task facilitation objects as correspond to the particular task to be facilitated. Then identify (103) particular supportable candidate capabilities as correspond to at least some of the particular supportable task facilitation objects followed by then determining (104), for at least some of the particular supportable candidate capabilities, a corresponding relative preference metric to provide a metricized preferences-and-cap abilities matrix as corresponds to the particular task and this particular apparatus. This metricized preferences-and-capabilities matrix can then be used (105) to negotiate a particular selection of capabilities to be employed in cooperation with the another entity when facilitating this particular task.

### TECHNICAL FIELD

This invention relates generally to apparatuses having autonomous task facilitation capabilities.

### BACKGROUND

Apparatuses having autonomous task facilitation capabilities are known in the art. These include apparatuses and tasks of many kinds. This reference to “autonomous” will be understood to refer to a native capability to effect core functionality in the absence of direct oversight. In many cases, such autonomy is guided and informed by one or more policies as have been provided to the apparatus for such purposes. Such a capability finds an ever-growing number of useful application settings and the number of apparatuses having autonomous task facilitation capabilities of one kind or another is growing as well.

In some cases, the performance of certain tasks may involve, necessarily or as a convenience, an interaction between two such apparatuses. As one salient example in this regard, a wireless communications device having autonomous task facilitation capabilities may need to negotiate and agree on a set of capabilities to employ in a given communication setting with another wireless communications device having similar capabilities. For example, two nodes establishing a secure tunnel will need to agree on security algorithms and key lengths to use for the secure communication. In another example, a client requesting certain service will negotiate with a server to agree on service type and delivery mechanisms for the service.

One approach in this regard seeks to avoid such a negotiation and provides for each such apparatus providing a complete list of its supported capabilities from which others may select. There are many problems associated with such an approach but undue simplicity (and the limitations that are the result of such simplicity) is certainly one of them. This simplicity can give rise to unfairness and potential privacy violation. By another approach, an automated negotiation serves to identify the capabilities to be used. In these cases, the negotiation tends to rely heavily upon so-called price negotiation models (as used in game theory, machine learning, and artificial intelligence research) and/or trust negotiation models (where credentials are exchanged, often in several phases as the relationship of trust is built).

These negotiation approaches focus on negotiating one object and they present any number of implementation challenges when applying them to negotiating using multiple objects for many application settings. These challenges can include, but are certainly not limited to, requiring considerable computational resources along with corresponding power consumption requirements, requiring considerable bandwidth to facilitate the relatively rich exchange of information between the two apparatuses, and a potential for considerable time being required to complete the negotiation. In general, as the number of objects used to negotiate increases, all of the above challenges also increase. This is also true as the complexity and diversity of the objects being negotiated increases.

### BRIEF DESCRIPTION OF THE DRAWINGS

The above needs are at least partially met through provision of the method and apparatus to facilitate negotiation of a selection of capabilities to be employed when facilitating a task described in the following detailed description, particularly when studied in conjunction with the drawings, wherein:

FIG. 1 comprises a flow diagram as configured in accordance with various embodiments of the invention;

FIG. 2 comprises a schematic representation as configured in accordance with various embodiments of the invention;

FIG. 3 comprises a flow diagram as configured in accordance with various embodiments of the invention;

FIG. 4 comprises a flow diagram as configured in accordance with various embodiments of the invention;

FIG. 5 comprises a call flow diagram as configured in accordance with various embodiments of the invention; and

FIG. 6 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, an apparatus having autonomous task facilitation capabilities (wherein the task to be facilitated comprises a plurality of supportable task facilitation objects and wherein at least some of the supportable task facilitation objects each have a plurality of supportable candidate capabilities by which the task facilitation object can be accomplished) can effect a process to facilitate negotiating a particular selection of capabilities to be employed in conjunction with another entity when facilitating a particular task.

The process can comprise determining a particular task to be autonomously facilitated in cooperation with another entity that also has autonomous task facilitation capabilities and then identifying particular supportable task facilitation objects that correspond to the particular task. The process can then provide for identifying particular supportable candidate capabilities as correspond to at least some of the particular supportable task facilitation objects and then determining, for at least some of the particular supportable candidate capabilities, a corresponding relative preference metric to provide a metricized preferences-and-capabilities matrix as corresponds to the particular task and this particular apparatus. This metricized preferences-and-capabilities matrix can then be used to negotiate a particular selection of capabilities to be employed in cooperation with the other entity when facilitating this particular task.

By one approach, this step of using the metricized preferences-and-capabilities matrix can comprise providing the metricized preferences-and-capabilities matrix to the another entity, receiving a metricized preferences-and-capabilities matrix for the another entity, and using both metricized preferences-and-capabilities matrixes to identify a candidate mutually acceptable selection of capabilities to be used to facilitate the particular task.

If desired, a particular dialogue protocol can serve to facilitate an orderly exchange of only portions of the metricized preferences-and-cap abilities matrix in a manner that permits the negotiation process to proceed in a rapid, orderly, efficient, and mutually beneficial manner while also avoiding the trust and bandwidth issues that might be faced when simply exchanging such metricized preferences-and-capabilities matrix information between two negotiating apparatuses.

So configured, apparatuses capable of autonomous task facilitation can negotiate with one another to their joint mutual advantage and optionally, in support of fairness, to identify a particular set of capabilities to be employed when facilitating a particular task. This reference to “fairness” refers to when two parties reach a compromise that they find to be mutually acceptable. These teachings permit, in many cases, a mutually-best selection of such capabilities in a manner that tends to resolve quickly and efficiently. Those skilled in the art will recognize and appreciate that these teachings can be readily leveraged and applied in a wide variety of application settings and will further understand that these teachings can be readily scaled to accommodate a very wide range of apparatuses, tasks, capabilities, and so forth.

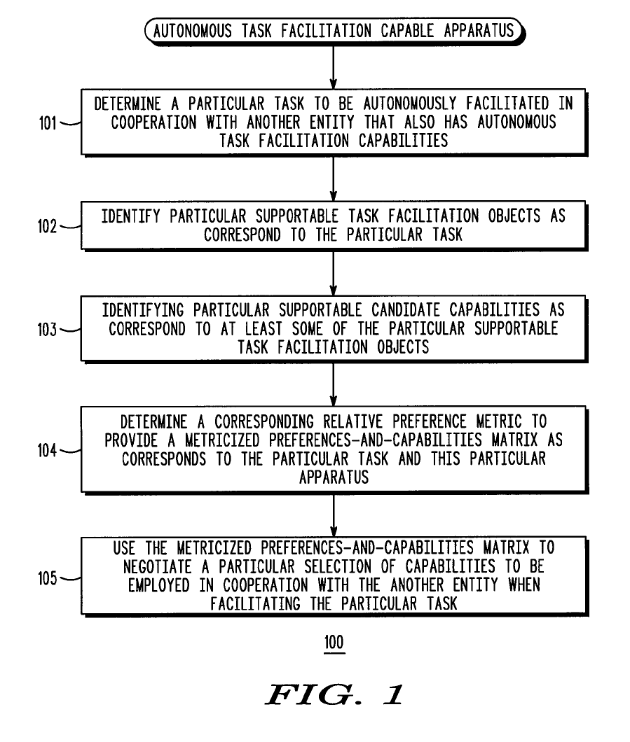

These and other benefits may become clearer upon making a thorough review and study of the following detailed description. Referring now to the drawings, and in particular to FIG. 1, an illustrative process that is compatible with many of these teachings will now be presented. This process 100 can be carried out, for example, by any of a wide variety of autonomous task facilitation capable apparatuses. For the purposes of illustration and not by way of example, this description will presume that this autonomous task facilitation capable apparatus comprises a device that supports two-way communications, such as a cellular telephone or the like.

This description of an illustrative process 100 also presumes that the task to be autonomously facilitated comprises a plurality of supportable task facilitation objects. As used herein, this reference to “supportable” will be understood to refer to task facilitation objects that the apparatus is, in fact, presently capable of supporting using native capabilities and resources and/or in conjunction with external resources or capabilities that are readily available to the apparatus. The task facilitation objects themselves will of course vary greatly from one application setting to another. Given the two-way communications paradigm of the present example, however, exemplary examples of such task facilitation objects include service type, encryption type, compression rates, modulation types, and so forth.

This description of an illustrative process 100 further also assumes that at least some of the aforementioned task facilitation objects each have a corresponding plurality of supportable candidate capabilities by which the task facilitation object can be accomplished. To again continue for the moment with the exemplary application setting noted above, and again by way of illustration, for a given apparatus a given task facilitation object such as encryption type might have corresponding supportable candidate capabilities such as DES, 3DES, AES, and so forth.

Pursuant to this process 100 the apparatus determines 101 a particular task to be autonomously facilitated in cooperation with another entity that also has autonomous task facilitation capabilities. This might comprise, for example, determining a present need to facilitate a given communications task such as establishing a two-communication link with this other entity. Such a determination might be self sourced (as when an end user of the apparatus provides an input to the apparatus that specifically requires the establishment of such a link) or might be based upon externally sourced stimuli (as when, for example the other entity has initiated an effort to establish a call session with the apparatus).

This process 100 then identifies 102 particular supportable task facilitation objects as correspond to the particular task. As a simple example in this regard, this could comprise identifying the communications capabilities (such as service type and encryption type) that the apparatus is able to support when supporting the task comprising the establishment and maintenance of the two-way communications link.

This process 100 then next identifies 103 particular supportable candidate capabilities as correspond to at least some of the particular supportable task facilitation objects. To continue the example begun above, when the particular supportable task facilitation objects comprise a service type object and an encryption type object, this step 193 might comprise, by way of illustration, identifying the supportable candidate capabilities “best effort” and “real time” for the service type object and the supportable candidate capabilities DES, 3DES, and AES for the encryption type object. This would serve to identify, for example, that this apparatus is presently capable of supporting the noted communications task by use of the task facilitation object service type using either of the two alternative supportable candidate capabilities “best effort” or “real time.”

This process 100 then determines 104, for at least some of the particular supportable candidate capabilities, a corresponding relative preference metric to thereby provide a metricized preferences-and-capabilities matrix as corresponds to the particular task and this particular apparatus. By one approach, for example, such a determination can be based, at least in part, upon use of previously specified policy information. Such policy information might be specific in nature or more relative and generalized as desired. Such policy information can comprise an essential part of the core operational fundamentals of the apparatus or can, for example, represent a more flexible approach (as when the policy information reflects choices and preferences that have been entered, one way or another, by an end user or administrator of the apparatus). (As used herein, the expression “previously specified” shall be understood to refer, at a minimum, to a time prior to the apparatus determining 101 that the particular task is to be autonomously facilitated.)

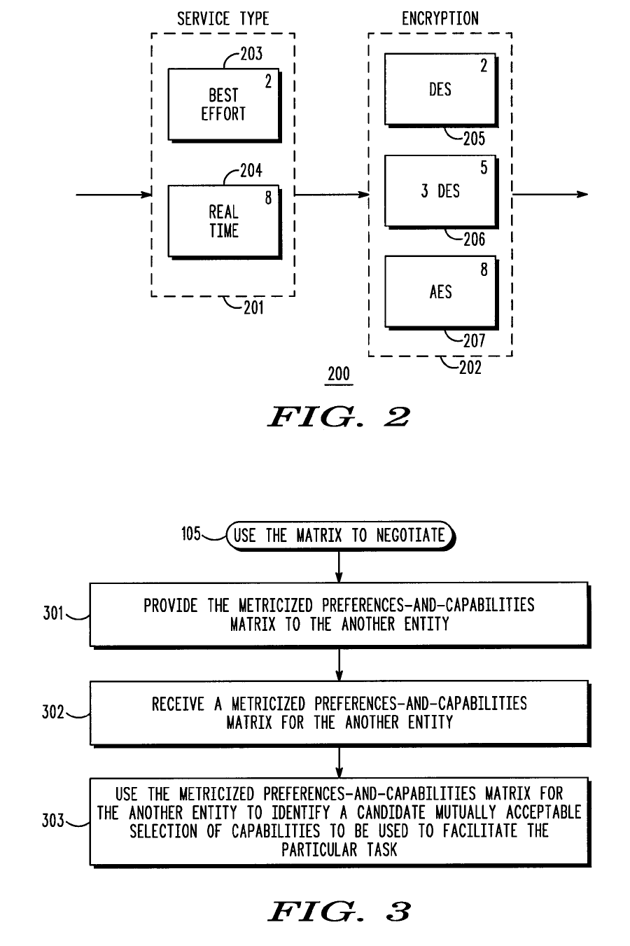

By way of illustration and with no intention of any limitations in this regard, and referring momentarily to FIG. 2, this can comprise, for example, using a weighting value of from “1” to “10” to indicate a relative preference for the corresponding supportable candidate capabilities. These teachings will accommodate a wide range of approaches in this regard. By one approach, for example, the sum total of these weighting values for the supportable candidate capabilities as correspond to a given task facilitation object must equal some predetermined value such as “10,” “15,” or the like. By this approach, a given value must be apportioned amongst the supportable candidate capabilities for a given task facilitation object in a corresponding manner. By another approach, such an aggregation constraint is not applied and each of the supportable candidate capabilities can be weighted as desired. In this latter case, the system can operate in accordance with known graph-theoretic practices that choose a path having the lowest sum of weights over all other paths; alternatively, other choices in this regard could be made as well.

By way of illustration, and again with no intention of limitations in this regard, as illustrated, a given task 200 to be facilitated involves, in turn, two supportable task facilitation objects; a service type 201 and an encryption type 202. The service type 201 task facilitation object, in turn, involves either to two supportable candidate capabilities, these being “best effort” 203 and “real time” 204. Similarly, the encryption type 202 task facilitation object, in turn, involves three supportable candidate capabilities, these being “DES” 205, “3DES” 206, and “AES” 207.

In this illustrative example, a corresponding relative preference metric has been assigned to each of these supportable candidate capabilities. For example, the “best effort” 203 supportable candidate capability has a relative preference metric of “2” while the “real time” 204 supportable candidate capability has a relative preference metric of “8.” These relative preference metrics, of course, reflect in this example a considerable preference for a “real time” service type as versus the “best effort” service type. Similarly, the relative preference metrics for the supportable candidate capabilities of the encryption type 202 reflect a primary relative preference for AES encryption, a medium-level relative preference for 3DES encryption, and a lesser relative preference for DES encryption.

The aforementioned metricized preferences-and-capabilities matrix can assume any of a wide variety of forms as will be well understood by those skilled in the art. This can include something as straight forward and simple as rows and columns to contain the various metric values (as a literal matrix) or something where the relationships between the metric values that reflect the preferences are related to the capabilities using other techniques such as links, nodes, or the like (as a virtual matrix).

Referring again to FIG. 1, this process 100 then provides for using 105 the metricized preferences-and-capabilities matrix to negotiate a particular selection of capabilities to be employed in cooperation with the other entity when facilitating the particular task. There are various ways by which such a negotiation can be effected. In general, the preferences reflected in the aforementioned metrics for various supportable candidate capabilities are employed to aid in relatively quickly identifying not only a mutual selection of such supportable candidate capabilities to be used when facilitating the task, but a selection from amongst such capabilities that constitutes a most mutually acceptable selection.

By one approach, and referring now to FIG. 3, this use 105 of the metricized preferences-and-capabilities matrix can comprise providing 301 the metricized preferences-and-capabilities matrix to the other entity while also receiving 302 a metricized preferences-and-capabilities matrix for that other entity. By this approach, both entities seeking to autonomously facilitate a given task have the complete aforementioned collection of information regarding each others supported capabilities which are relevant to the task to be facilitated along with the metrics that reflect their respective preferences regarding the use of each such capability. The apparatus can then use 303 the metricized preferences-and-capabilities matrix for both itself and the other entity to identify a candidate mutually acceptable selection of capabilities to be used to facilitate the particular task.

This information can be employed to quickly identify a particular selection of such capabilities that is mutually supportable by both entities and further that is least objectionable to both entities (where the selection represents an available selection that has a best overall preferences metric value accumulated score. By one approach, this can comprise, at least in part, identifying a candidate mutually acceptable selection of capabilities that minimizes dissatisfaction for both the apparatus and the other entity. This, again, can be measured in various ways. By one approach, this can be determined by simply summing the weight value for each selected capability of the candidate selection of capabilities for both entities and comparing them as desired.

By one approach, it might be assumed that both entities will come to a same conclusion regarding this identification of a mutually acceptable selection of capabilities. Accordingly, if desired and by one approach, one may simply provide for both entities to now begin the facilitation of the task by mutual albeit unilateral use of the selected capabilities. By another approach, however, these teachings will accommodate confirming a particular selection of capabilities as between these entities. This might comprise, for example, simply providing a message to identify the apparent selection and receiving an explicit or tacit acknowledgement of that particular selection.

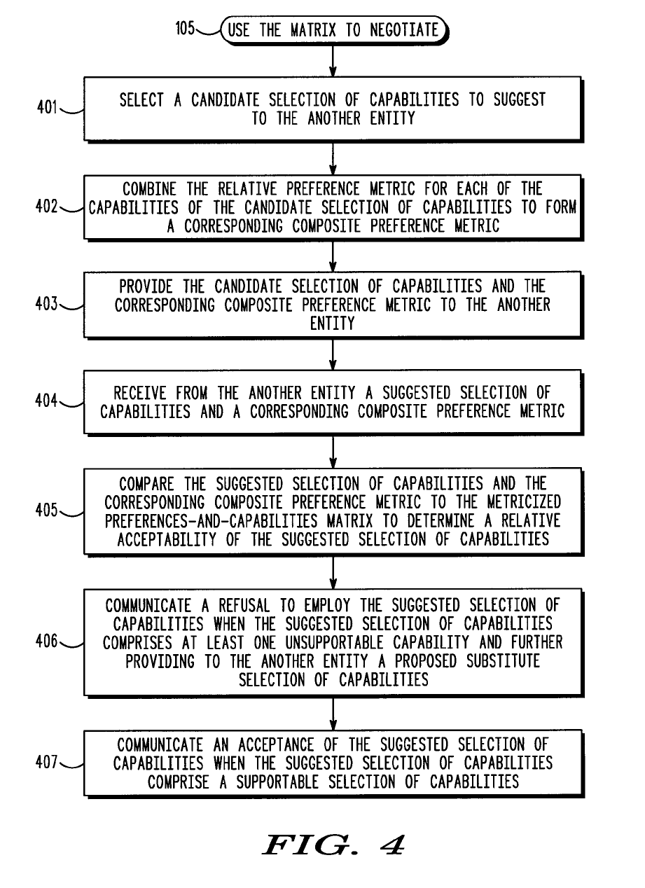

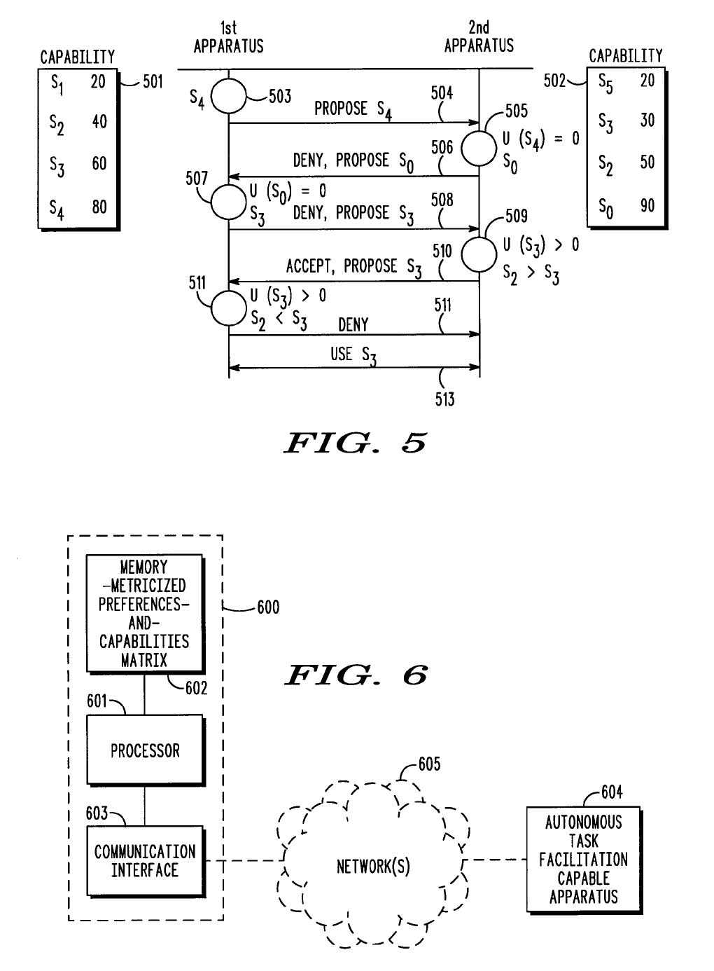

Such an approach requires, of course, that both entities fully trust one another with the complete body of metricized preferences-and-capabilities matrix information. This approach also requires, as noted, an exchange of the full body of information and this, in turn, requires both adequate bandwidth and time. Therefore, depending upon the application setting, such an approach may not be fully adequate to address immediate needs and/or sensitivities. Referring now to both FIGS. 4 and 5, then, an alternative approach to the usage 105 of the metricized preferences-and-cap abilities matrix will be presented.

Referring momentarily only to FIG. 5, for the purposes of this illustrative example, each of the apparatuses has accomplished the foregoing steps to the point of having developed their respective metricized preferences-and-capabilities matrixes. Each apparatus has then aggregated the weight values as correspond to each viable combination of those available capabilities. This, in turn, yields a group of capabilities 501 and 502 for each of the apparatuses where each set of capabilities has a corresponding aggregated value. This might comprise, by one simple approach, summing the weight values for each selected capability of each set of selected candidate capabilities.

Accordingly, in this simple example, the first apparatus has four candidate sets of capabilities 501. These candidate sets are denoted as S1, S2, S3, and S4 for the first apparatus and S0, S2, S3, and S5 for the second apparatus. Each candidate set, in turn, has a corresponding score that represents an aggregation of the weight values as correspond to the particular capabilities that comprise each candidate set. In this example, the higher the score, the more preferred the candidate selection to this first apparatus. So configured, for example, the candidate set denoted as S1 is the least preferred candidate selection for the first apparatus (although this candidate set is, in fact, comprised of capabilities that are “supported” and “available” and hence can be used by the first apparatus if such usage is necessary).

This alternative approach to use of the metricized preferences-and-capabilities matrixes makes selective use of these composite preference metrics to permit an iterative negotiation process whereby the apparatuses are able to successfully and quickly determine an appropriate mutually useful set of capabilities to employ when facilitating their task without actually transmitting and disclosing their entire metricized preferences-and-capabilities matrixes. This particular approach may be viewed as employing “partial trust”, as differentiated from the earlier-described approach where full trust is presumed and where each entity simply sends their metricized preferences-and-cap abilities matrix to the other entity. One advantage of a partial trust approach is that less information has to be provided (at least initially), and hence a lower level of trust is appropriate. One disadvantage as compared to a full trust is that the process can require more time. Obviously, other variants will be evident to those skilled in the art; hence, their lack of definition here should not be construed as limiting in any way.

With this in mind, and referring again to both FIGS. 4 and 5, this approach has a first one of the apparatuses selecting 401 a candidate selection of capabilities to suggest to the other apparatus. In this illustrative example, the first apparatus selects 503 its most preferred candidate selection of capabilities, S4. This first apparatus then combines the relative preference metric as described above for each of the capabilities of the candidate selection of capabilities to form the aforementioned composite preference metric, as shown at reference numeral 402. In this illustrative example, the composite preference metric for S4 is the value “80.”

This apparatus then provides 403, via a corresponding message 504, the candidate selection of capabilities S4 along with the corresponding composite preference “80” to the second apparatus. This second apparatus receives 404 this communication and compares 405 the suggested selection of capabilities and the corresponding composite preference metric to its own metricized preferences-and-capabilities matrix to determine a relative acceptability of the suggested selection of capabilities.

When, for example, the proposed selection of capabilities happens to also be a most preferred selection of capabilities for the second apparatus, the second apparatus could simply accept that suggestion. The two apparatuses would then proceed to facilitate the task using a set of capabilities that was most preferred to both of them.

In this illustrative example, such is not the case. Instead, in this example, the set of capabilities S4 includes at least one capability that does not comprise a supportable capability for the second apparatus. Upon making this determination at 505, the second apparatus then instead selects its own most preferred candidate selection of capabilities which is represented here as S0 and transmits that selection along with the corresponding composite preference metric “90” in a message 506 that also includes a denial of the first apparatus's proposal regarding the S4 selection of capabilities.

By one approach, this communication 406 of a refusal to employ the suggested selection of capabilities can be understood by the apparatuses as indicating that the suggested selection of capabilities comprises at least one unsupportable capability. By this approach, then, the presentation of the alternative suggested selection of capabilities can be understood as a proposed substitute selection of capabilities.

In this illustrative example, the first apparatus determines at 507 that the suggested selection of capabilities represented by S0 includes at least one capability that the first apparatus is incapable of supporting. Accordingly, the first apparatus will now communicate 406 a message 508 that comprises, in part, another denial in this regard. This communication also includes another proposed substitute selection of capabilities which comprises the next most preferred selection of capabilities S3 along with its composite preference metric (which comprises, in this illustrative example, the value “60”).

In this example, upon receiving this new proposal, the second apparatus determines at 509 that this next suggested selection of capabilities S3 in fact comprises a selection of capabilities that the second apparatus can support. The second apparatus also determines, however, that this S3 selection of capabilities has a composite preference metric of “30” and that there is another selection of capabilities, S2, which has a higher composite preference metric (i.e., “50”) which has not yet been vetted via the described process. Accordingly, it can be determined that the suggested selection of capabilities S3, though supportable, comprises a selection of capabilities having a corresponding composite preference metric that is less favorable than the alternative selection of capabilities S2.

This being the case, the second apparatus now communicates 407 a message 510 that comprises an acceptance of the suggested selection of capabilities (i.e., an acceptance of S3) to indicate and represent that the suggested selection of capabilities in fact comprises a supportable selection of capabilities. Notwithstanding this acceptance, however, the second apparatus also includes in this message 510 yet another suggested selection of capabilities (i.e., S2) along with the composite preference metric value “50” as corresponds to that suggested selection of capabilities.

Upon receiving this acceptance and counter-suggestion message 510, the first apparatus first determines that the newly proffered selection of capabilities S2 is in fact a selection of capabilities that the first apparatus can support. Were this not the case, the first apparatus would simply deny the new suggestion on that basis.

Since the first apparatus can support S2, the first apparatus then compares the composite preference metric values for both the earlier agreed-to suggestion S3 and the newly suggested S2 set of capabilities. In this particular example, S3 has a composite preference metric of 60 while S2 has a composite preference metric of 50. As S3's metric is larger than S2's metric, the first apparatus determines at 511 that, overall, a better level of satisfaction is achieved by remaining with the earlier choice S3. Accordingly, the first apparatus communicates a message 512 to the second apparatus to deny this new suggestion regarding S2 and the two apparatuses then use 513 the S3 selection of capabilities to facilitate their task.

Note that other variations of the above approach are within the scope of these teachings. For example, an entity B may receives from another entity A a capabilities-preferences matrix that is acceptable but not optimal. That is, while all capabilities in this matrix meet their individual prescribed preference, either the combined total preference value and/or one or more individual preferences are less than the preference of the entity B that this message was sent to. In such a case, entity B could reply with a special code having the meaning “accept with suggestion” to signal to the other entity A that while the matrix that the other entity A sent is acceptable, entity B would like the other entity A to consider a new matrix that entity B is sending to the other entity A in this message.

One possible advantage of this alteration, at least in some application settings, is that this alteration avoids an early termination to the negotiation algorithm in favor of finding the optimal result. In this example, when the other entity A receives the accept with suggestion message from entity B, it knows that it has already arrived at an acceptable solution. However, its partner, entity B, is asking if an optimization can be made. If this optimization can be made, then the other entity A will send to entity B an accept message (which indicates that the negotiation ends with the matrix sent by entity B), an accept with suggestion message (which indicates yet another chance for further optimization), or a reject message (indicating no, and to stay with the message that A sent which caused B to issue the original accept with suggestion message).

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 6, an illustrative approach to such a platform will now be provided.

The illustrated apparatus 600 can be presumed to have task facilitation capabilities as described above. The apparatus 600 comprises, pertinent to these teachings, a processor 601 that operably couples to a memory 602 and a communication interface 603. Those skilled in the art will recognize and appreciate that such a processor 601 can comprise a fixed-purpose hard-wired platform or can comprise a partially or wholly programmable platform. All of these architectural options are well known and understood in the art and require no further description here.

The memory 602 can serve to contain and store the aforementioned metricized preferences-and-capabilities matrix and the communications interface 603 can comprise a point of connection between the apparatus 600 and, for example, another autonomous task facilitation capable apparatus 604 via one or more intervening networks 605 (which may be wireless or wired, in whole or in part).

The processor 601 can be configured and arranged (using, for example, appropriate programming as will be well understood by those skilled in the art) to carry out one or more of the steps, actions, and functions described herein. This can include, but is not limited to, the various described steps regarding the identification of particular supportable task facilitation objects as corresponds to a particular task to be accomplished in conjunction with the other apparatus, the identification of supportable candidate capabilities as correspond to at least some of these particular supportable task facilitation objects, the determination (for at least some of these supportable candidate capabilities) of a corresponding relative preference metric to provide the aforementioned metricized preferences-and-capabilities matrix as corresponds to this particular task and this particular apparatus, and the use (in any of the described ways or via other ways) of this metricized preferences-and-capabilities matrix to negotiate a particular selection of capabilities to be employed in cooperation with the other apparatus when facilitating the task.

Those skilled in the art will recognize and understand that such an apparatus 600 may be comprised of a plurality of physically distinct elements as is suggested by the illustration shown in FIG. 6. It is also possible, however, to view this illustration as comprising a logical view, in which case one or more of these elements can be enabled and realized via a shared platform. It will also be understood that such a shared platform may comprise a wholly or at least partially programmable platform as are known in the art.

So configured, it will be understood and appreciated that these teachings can be usefully employed, in a variety of different ways, to permit entities capable of autonomous task facilitation to work with one another using a negotiated set of supporting capabilities that are (1) supportable by both entities and (2) that represent as well a relatively optimum choice in this regard. As one illustrative example in this regard, these teachings are readily employed in an intra-domain application setting (for example, an application setting comprising a single administrative domain where presumably a certain useful level of trust already exists) having heterogeneous devices (supplied, for example, by different vendors, in different versions, with differing capabilities) that must somehow negotiate multiple objects in order to effect useful communications amongst themselves.

It will also be understood that these teachings are highly leveragable and can be employed with any of a wide variety of implementing apparatuses and in a wide variety of application settings. It will also be appreciated that these teachings are highly scalable and can serve well with a wide range of task facilitation objects and supportable candidate capabilities.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. As but one example in this regard, these teachings can be readily extended to permit a similar negotiation regarding supporting capabilities amongst three or more such apparatuses.

We claim:

1. A method comprising:
at an apparatus having autonomous task facilitation capabilities, wherein the task to be facilitated comprises a plurality of supportable task facilitation objects and wherein at least some of the supportable task facilitation objects each have a plurality of supportable candidate capabilities by which the task facilitation object can be accomplished:
determining a particular task to be autonomously facilitated in cooperation with another entity that also has autonomous task facilitation capabilities;
identifying particular supportable task facilitation objects as correspond to the particular task;
identifying particular supportable candidate capabilities as correspond to at least some of the particular supportable task facilitation objects;
determining, for at least some of the particular supportable candidate capabilities, a corresponding relative preference metric to provide a metricized preferences-and-cap abilities matrix as corresponds to the particular task and this particular apparatus;
using the metricized preferences-and-capabilities matrix to negotiate a particular selection of capabilities to be employed in cooperation with the another entity when facilitating the particular task.

2. The method of claim 1 wherein:
the particular task comprises, at least in part, a communications task; and
the particular supportable task facilitation objects each comprise an object as corresponds to a communications capability.

3. The method of claim 1 wherein determining, for at least some of the particular supportable candidate capabilities, a corresponding relative preference metric to provide a metricized preferences-and-capabilities matrix as corresponds to the particular task and this particular apparatus comprises, at least in part, using previously specified policy information to determine the corresponding relative preference metrics.

4. The method of claim 1 wherein using the metricized preferences-and-cap abilities matrix to negotiate a particular selection of capabilities to be employed in cooperation with the another entity when facilitating the particular task comprises, at least in part:
providing the metricized preferences-and-capabilities matrix to the another entity;
receiving a metricized preferences-and-capabilities matrix for the another entity;
using the metricized preferences-and-capabilities matrix for the another entity to identify a candidate mutually acceptable selection of capabilities to be used to facilitate the particular task.

5. The method of claim 4 wherein using the metricized preferences-and-capabilities matrix for the another entity to identify a candidate mutually acceptable selection of capabilities to be used to facilitate the particular task comprises, at least in part, identifying a candidate mutually acceptable selection of capabilities that minimizes dissatisfaction for at least one of the apparatus and the another entity.

6. The method of claim 5 wherein using the metricized preferences-and-capabilities matrix for the another entity to identify a candidate mutually acceptable selection of capabilities to be used to facilitate the particular task comprises, at least in part, identifying a candidate mutually acceptable selection of capabilities that minimizes dissatisfaction to both entities.

7. The method of claim 1 wherein using the metricized preferences-and-capabilities matrix to negotiate a particular selection of capabilities to be employed in cooperation with the another entity when facilitating the particular task comprises, at least in part:
selecting a candidate selection of capabilities to suggest to the another entity;
combining the relative preference metric for each of the capabilities of the candidate selection of capabilities to form a corresponding composite preference metric;
providing the candidate selection of capabilities and the corresponding composite preference metric to the another entity.

8. The method of claim 1 wherein using the metricized preferences-and-capabilities matrix to negotiate a particular selection of capabilities to be employed in cooperation with the another entity when facilitating the particular task comprises, at least in part:
receiving from the another entity a suggested selection of capabilities and a corresponding composite preference metric;
comparing the suggested selection of capabilities and the corresponding composite preference metric to the metricized preferences-and-capabilities matrix to determine a relative acceptability of the suggested selection of capabilities.

9. The method of claim 8 wherein using the metricized preferences-and-cap abilities matrix to negotiate a particular selection of capabilities to be employed in cooperation with the another entity when facilitating the particular task further comprises, at least in part:
communicating a refusal to employ the suggested selection of capabilities when the suggested selection of capabilities comprises at least one unsupportable capability and further providing to the another entity a proposed substitute selection of capabilities.

10. The method of claim 8 wherein using the metricized preferences-and-cap abilities matrix to negotiate a particular selection of capabilities to be employed in cooperation with the another entity when facilitating the particular task further comprises, at least in part:
communicating an acceptance of the suggested selection of capabilities when the suggested selection of capabilities comprises a supportable selection of capabilities.

11. The method of claim 10 wherein communicating an acceptance of the suggested selection of capabilities when the suggested selection of capabilities comprises a supportable selection of capabilities comprises also providing an alternative selection of capabilities and a corresponding composite preference metric to the another entity when the suggested selection of capabilities, though supportable, comprises a selection of capabilities having a corresponding composite preference metric that is less favorable than the alternative selection of capabilities.

12. The method of claim 8 wherein using the metricized preferences-and-capabilities matrix to negotiate a particular selection of capabilities to be employed in cooperation with the another entity when facilitating the particular task further comprises, at least in part:
communicating to the another entity a conditional acceptance of the suggested selection of capabilities when the suggested selection of capabilities comprises a supportable selection of capabilities, the conditional acceptance being comprised of:
a new proposed selection of capabilities with corresponding new composite preference metrics in the above message;
a conditional acceptance message to indicate that the another entity should note that the suggested selection of capabilities sent by the another entity has been accepted, but that the another entity should now consider the new proposed selection of capabilities and respond using one of at least three candidate and available responses comprising:
an indication that a previously offered conditional acceptance capability selection is to be employed;
an indication that the new proposed selection of capabilities is to be employed;
an indication to signal another conditional acceptance to thereby indicate that the another entity has accepted the new proposed selection of capabilities but that the another entity is also seeking consideration of a newer proposed selection of capabilities.

13. An apparatus having autonomous task facilitation capabilities, wherein the task to be facilitated comprises a plurality of supportable task facilitation objects and wherein at least some of the supportable task facilitation objects each have a plurality of supportable candidate capabilities by which the task facilitation object can be accomplished, the apparatus comprising:
a communications interface;
a processor operably coupled to the communication interface and being configured and arranged to:
determine a particular task to be autonomously facilitated in cooperation with another entity that also has autonomous task facilitation capabilities;
identify particular supportable task facilitation objects as correspond to the particular task;
identify particular supportable candidate capabilities as correspond to at least some of the particular supportable task facilitation objects;
determine, for at least some of the particular supportable candidate capabilities, a corresponding relative preference metric to provide a metricized preferences-and-capabilities matrix as corresponds to the particular task and this particular apparatus;
use the metricized preferences-and-capabilities matrix to negotiate a particular selection of capabilities to be employed in cooperation with the another entity when facilitating the particular task.

14. The apparatus of claim 13 wherein the processor is further configured and arranged to determine, for at least some of the particular supportable candidate capabilities, a corresponding relative preference metric to provide a metricized preferences-and-cap abilities matrix as corresponds to the particular task and this particular apparatus by, at least in part, using previously specified policy information to determine the corresponding relative preference metrics.

15. The apparatus of claim 13 wherein the processor is further configured and arranged to use the metricized preferences-and-capabilities matrix to negotiate a particular selection of capabilities to be employed in cooperation with the another entity when facilitating the particular task by, at least in part:
providing the metricized preferences-and-capabilities matrix to the another entity;
receiving a metricized preferences-and-capabilities matrix for the another entity;
using the metricized preferences-and-capabilities matrix for the another entity to identify a candidate mutually acceptable selection of capabilities to be used to facilitate the particular task.

16. The apparatus of claim 15 wherein the processor is further configured and arranged to use the metricized preferences-and-capabilities matrix for the another entity to identify a candidate mutually acceptable selection of capabilities to be used to facilitate the particular task by, at least in part, identifying a candidate mutually acceptable selection of capabilities that minimizes dissatisfaction for both the apparatus and the another entity.

17. The apparatus of claim 15 wherein the processor is further configured and arranged to use the metricized preferences-and-capabilities matrix to negotiate a particular selection of capabilities to be employed in cooperation with the another entity when facilitating the particular task by, at least in part:
confirming with the another entity the particular selection of capabilities.

18. The apparatus of claim 13 wherein the processor is further configured and arranged to use the metricized preferences-and-capabilities matrix to negotiate a particular selection of capabilities to be employed in cooperation with the another entity when facilitating the particular task by, at least in part:
selecting a candidate selection of capabilities to suggest to the another entity;
combining the relative preference metric for each of the capabilities of the candidate selection of capabilities to form a corresponding composite preference metric;
providing the candidate selection of capabilities and the corresponding composite preference metric to the another entity.

19. The apparatus of claim 13 wherein the processor is further configured and arranged to use the metricized preferences-and-capabilities matrix to negotiate a particular selection of capabilities to be employed in cooperation with the another entity when facilitating the particular task by, at least in part:
receiving from the another entity a suggested selection of capabilities and a corresponding composite preference metric;
comparing the suggested selection of capabilities and the corresponding composite preference metric to the metricized preferences-and-capabilities matrix to determine a relative acceptability of the suggested selection of capabilities.

20. The apparatus of claim 19 wherein the processor is further configured and arranged to use the metricized preferences-and-capabilities matrix to negotiate a particular selection of capabilities to be employed in cooperation with the another entity when facilitating the particular task by, at least in part:
communicating a refusal to employ the suggested selection of capabilities when the suggested selection of capabilities comprises at least one unsupportable capability and further providing to the another entity a proposed substitute selection of capabilities.
